(19) United States
(12) Patent Application Publication
(10) Pub. No.: US 2005/0230218 A1
(43) Pub. Date: Oct. 20, 2005

(54) Slot lock for a cart

(76) Inventor: Wen-Chiu Wu, Chang Hua Hsien (TW)

Correspondence Address: HERSHKOVITZ & ASSOCIATES, 1725 I STREET NW, SUITE 300, WASHINGTON, DC, 20006, US

(21) Appl. No.: 11/075,735

(22) Filed: Mar. 10, 2005

(30) Foreign Application Priority Data
Apr. 19, 2004 (TW) 093206026

(51) Int. Cl. G07F 5/00; G07F 11/00; G07F 13/00; G07F 15/00; G07F 17/00; E05B 27/06; E05B 29/14; E05B 31/00

(52) U.S. Cl. 194/286

(57) ABSTRACT

A slot lock has a housing, a key and a locking device. The housing has an upper shell and a lower shell. The upper shell has a slot and a key hole. The locking device has two locking arms, a connecting arm, a first biasing member and a second biasing member. The locking arms are pivotally mounted in the upper shell and each has a key-clamping end, a tab and a coin-holding end. The connecting arm has two ends engaging respectively with the tabs on the locking arms. The first biasing member is mounted between the upper shell and the connecting arm and has two ends connected respectively to the locking arms. The second biasing member has two ends connected to the upper shell and a middle provided with a stop corresponding to the slot.

### BACKGROUND OF THE INVENTION

1. Field of the Invention

The present invention relates to a slot lock, and more particularly to a slot lock for a cart.

2. Description of Related Art

Carts are always arranged in super markets or shopping malls to assist customers to carry the selected objects they want and purchase. A slot lock is commonly mounted on a cart to connect multiple carts in series, such that an employee of a super market or shopping mall can manage the carts efficiently. The slot lock substantially comprises a housing, a locking device, a chain and a key. The housing has a slot and a key hole defined respectively in two ends of the housing. The locking device is mounted in the housing and corresponds to the slot and the key hole. The chain is attached to the housing, and the key is attached to the chain. To connect two carts with the slot lock, the key of the slot lock on one cart is inserted into the key hole and is held by the locking device of the slot lock on the other cart. When a coin is inserted into the slot, the engagement between the locking device and the key will be released. Consequently, a purchaser can use that cart to carry objects. After purchasing, the key hole of the slot lock is inserted by the key on another cart, and the coin will be disengaged by the locking device and is discharged from the slot.

However, in the conventional slot lock, the releasing movement of the coin is not enough, such that the user always must pull the coin out of the slot with large force and the use of the conventional slot lock is inconvenient.

To overcome the shortcomings, the present invention tends to provide a slot lock to mitigate or obviate the aforementioned problems.

### SUMMARY OF THE INVENTION

The main objective of the invention is to provide a slot lock for a cart and one that is convenient in use. The slot lock has a housing, a key and a locking device. The housing has an upper shell and a lower shell. The upper shell has a slot defined in one end and a key hole defined in the other end and corresponding to the slot. The lower shell is combined to the upper shell. The key is connected to the housing. The locking device is mounted in the housing and has two locking arms, a connecting arm, a first biasing member and a second biasing member. The locking arms are pivotally mounted in the upper shell and each has a key-clamping end, a tab and a coin-holding end. The key-clamping end extends toward the key hole. The tab extends from the locking arm near the concave key-clamping end. The coin-holding end is opposite to the key-clamping end and has a concave surface for holding a coin. The connecting arm is mounted between the locking arms and has two ends engaging respectively with the tabs on the locking arms. The first biasing member is mounted between the upper shell and the connecting arm and has two ends connected respectively to the locking arms. The second biasing member is mounted in the upper shell near the slot and has two ends connected to the upper shell and a middle provided with a stop corresponding to the slot.

Other objects, advantages and novel features of the invention will become more apparent from the following detailed description when taken in conjunction with the accompanying drawings.

### BRIEF DESCRIPTION OF THE DRAWINGS

FIG. 1 is an operational perspective view of two slot locks in accordance with the present invention;

FIG. 2 is an exploded perspective view of a slot lock in FIG. 1;

FIG. 3 is an exploded perspective view of the upper shell, the locking device and the chain with key of the slot lock in FIG. 2;

FIG. 4 is an operational top plan view of the slot lock in FIG. 2 showing the locking device before a key is inserted;

FIG. 5 is an operational top plan view of the slot lock in FIG. 2 showing the operation of the locking device when the key is inserted into the key hole and a coin is released from the slot;

FIG. 6 is a side plan view in partial cross section of the slot lock in FIG. 5;

FIG. 7 is front plan view in partial cross section of the slot lock in FIG. 5; and

FIG. 8 is an operational top plan view of the slot lock in FIG. 2 showing the operation of the locking device when a coin is inserted into the slot.

### DETAILED DESCRIPTION OF PREFERRED EMBODIMENT

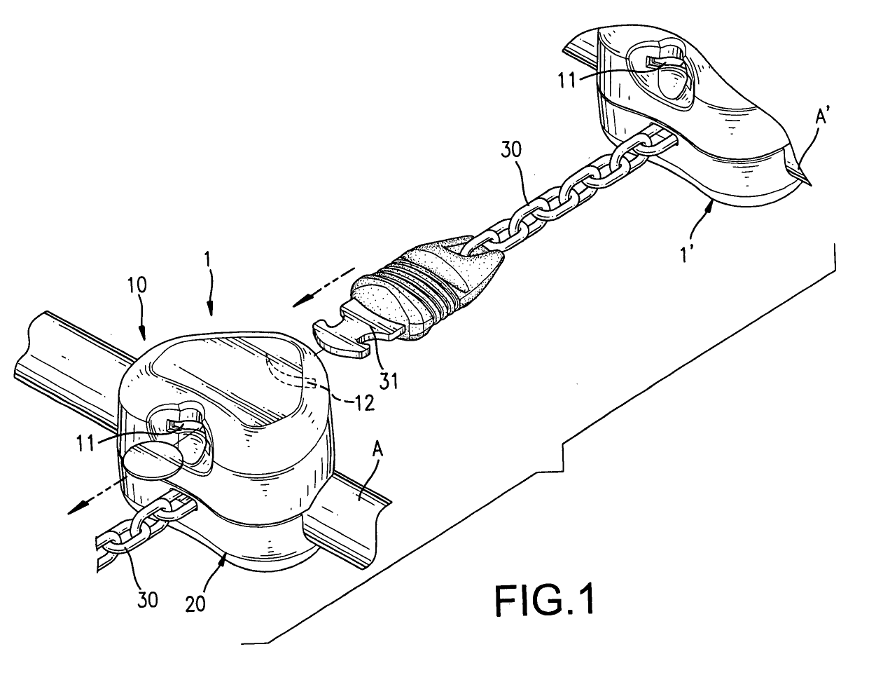

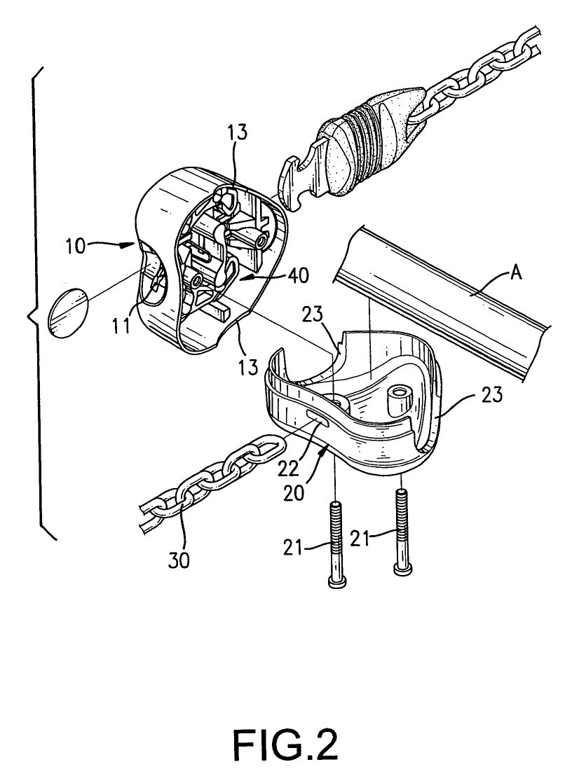

With reference to FIGS. 1 to 3, a slot lock for a cart in accordance with the present invention comprises a housing (1), a key (31) and a locking device (40). The housing (1) is attached to a handle (A) of the cart and comprises an upper shell (10) and a lower shell (20). The upper shell (10) has two ends, a slot (11) defined in one end and a key hole (12) defined in the other end and corresponding to the slot (11). The lower shell (20) is combined with the upper shell (10) by bolts (21). Each shell (10,20) has two sides provided respectively with a recess (13,23) to hold the handle (A) in cooperation.

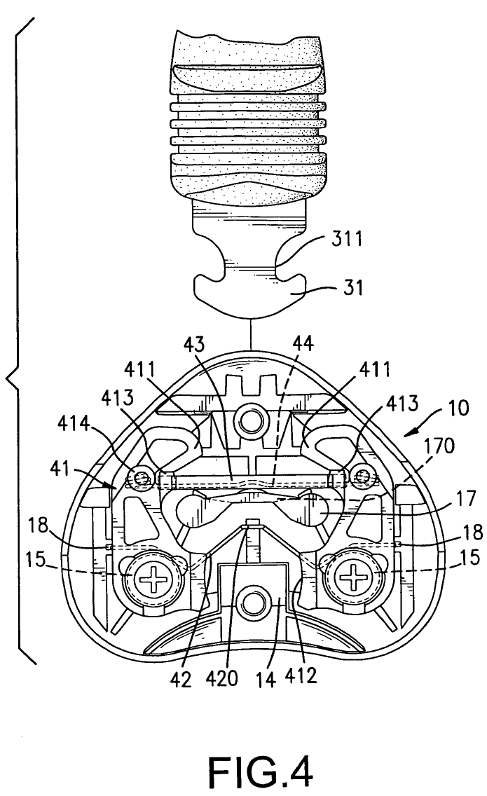

The upper shell (10) further has a coin stand (14), a key stand (16), multiple posts (15), a partition wall (17) and two insert holes (18), as shown in FIG. 4. The coin stand (14) is formed in the upper shell (10) and corresponds to the slot (11) to hold a coin inserted into housing (1) through the slot (11). The key stand (16) is formed in the upper shell (10) and corresponds to the key hole (12) to hold the key (31) inserted into the housing (1) through the key hole (12). Each post (15) has a threaded hole for screwing with one of the bolts (21) to securely combine the shells (10,20). The partition wall (17) is formed in the upper shell (10) between the coin stand (14) and the key stand (16). The partial wall (17) has an elongated through hole (170) defined through the partition wall (17) and aligning with the slot (11) and the key hole (12). The insert holes (18) are defined in the upper shell (10) respectively at two sides of the upper shell (10) and are located between the coin stand (14) and the partition wall (17).

The key (31) is connected to the lower shell (20) through a chain (30). The key (31) has a head (310) and two cavities (311) respectively defined in two sides of the key (31) to form a neck connected to the head (310). In addition, the lower shell (20) further has an elongated through hole (22) for one end of the chain (30) penetrating into the lower shell (20). One of the bolts (21) extends through the chain (30) to securely connect the chain (30) to the lower shell (20).

With further reference to FIG. 4, the locking device (40) is mounted in the housing (1) and comprises two locking arms (41), a connecting arm (43), a first biasing member (44) and a second biasing member (42).

The locking arms (41) are pivotally mounted in the upper shell (10) with pivots. Each locking arm (41) comprises a key-clamping end (411), a tab (413) and a coin-holding end (410). The key-clamping end (411) is formed on one end of the locking arm (41) and extends toward the key hole (12). The tab (413) extends from the locking arm (41) near the key-clamping end (411). The coin-holding end (410) is formed on the other end of the locking arm (41) opposite to the key-clamping end (411) and has a concave surface (412) for holding a coin.

The connecting arm (43) is mounted between the locking arms (41) and has two ends provided with notches (431) engaging respectively with the tabs (413) on the locking arms (41). The connecting arm (43) has a concave bottom (430).

The first biasing member (44) is mounted between the upper shell (10) and the connecting arm (43) and has two ends connected respectively to the locking arms (41). In an operational embodiment, a through hole (414) is defined through each locking arm (41) near the tab (413) to hold one end of the first biasing member (44) inside.

The second biasing member (42) is mounted in the upper shell (10) between the slot (11) and the partition wall (17). The second biasing member (42) has two ends connected to the upper shell (10) and a middle provided with a stop (420) extending toward the lower shell (20) and corresponding to the slot (11). In an optional embodiment, the ends of the second biasing member (42) are inserted respectively into the insert holes (18) in the upper shell (10).

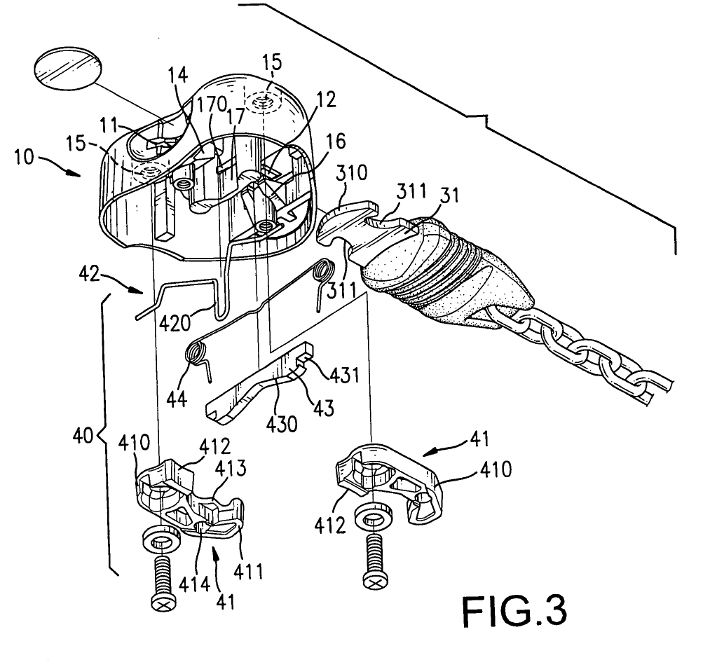

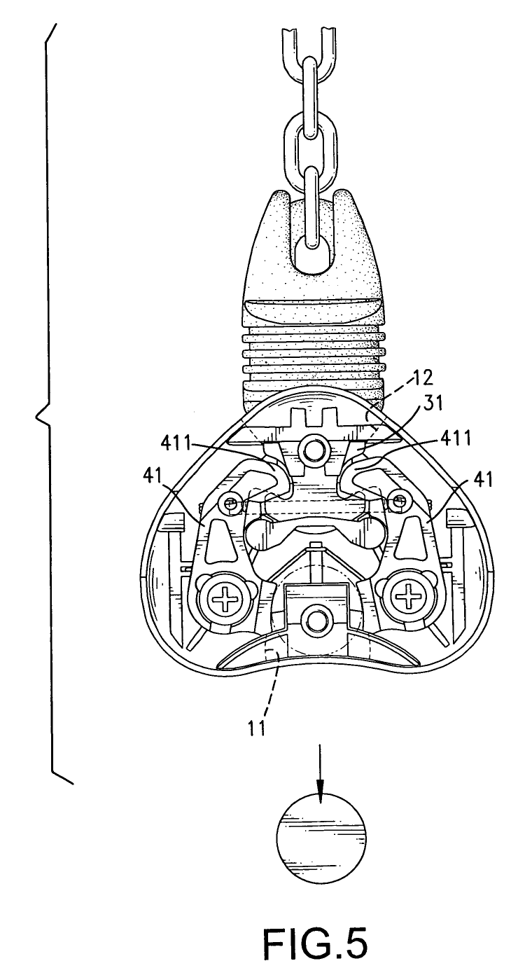

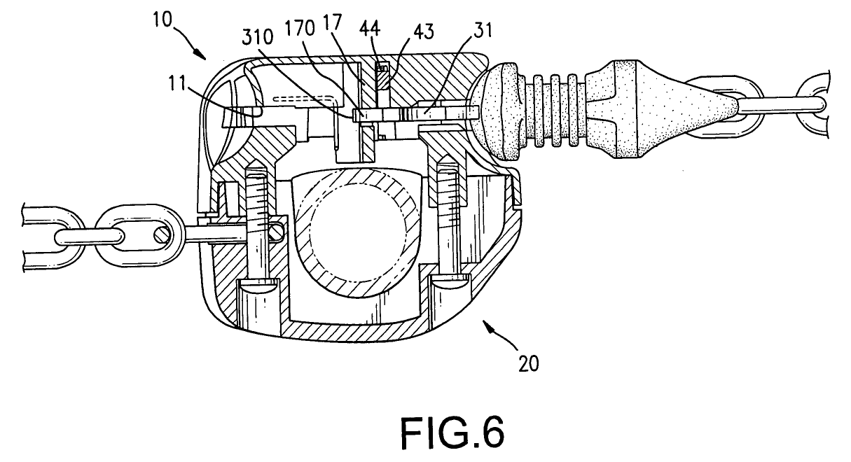

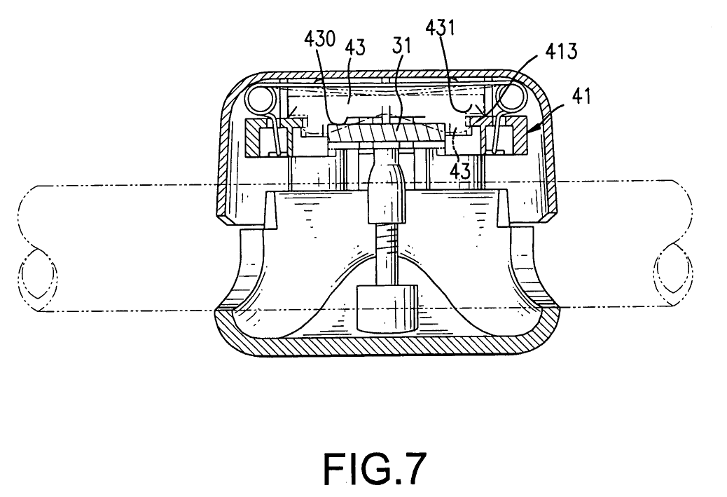

With reference to FIGS. 3 and 5 to 7, when the key (31) of a slot lock mounted on another cart is inserted into the key hole (12) in the housing (1), the head (310) of the key (31) will push the key-clamping ends (411) of the locking arms (41). The locking arms (41) will pivotally rotate relative to the housing (1), and the tabs (413) will disengage from the notches (431) on the connecting arm (43). The connecting arm (43) will be pushed to move upward by the key (31) when the head (310) abuts against the concave bottom (430) of the connecting arm (43). Accordingly, a first restitution force is generated in the first biasing member (44) to force the connecting arm (43) to move downward. With the pivotal rotation of the locking arms (41), two ends of the first biasing member (44) will be stretched, and a second restitution force will be generated in the first biasing member (44) to pull the locking arms (41) rotating back.

When the head (310) of the key (31) is inserted into the elongated through hole (170) in the partition wall (17), the neck will face the key-clamping ends (411) of the locking arms (41). The locking arms (41) will rotate back to engage the cavities (311) in the key (31) with the key-clamping ends (411), and the key (31) can be kept from escaping from the key hole (12) even when a force is applied to the chain (30). Accordingly, two carts with slot locks will be connected together to assist the keepers of supermarkets or shopping malls to manage the carts.

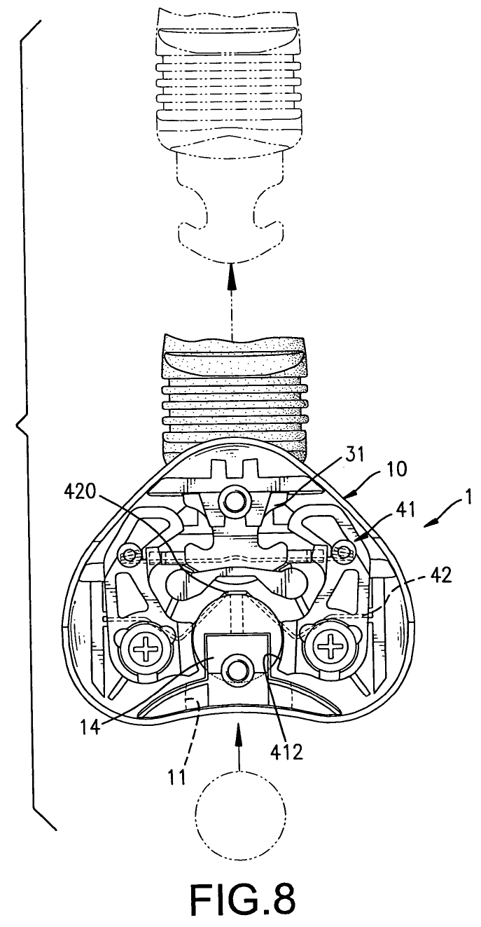

When a coin is inserted into the housing (1) through the slot (11), with further reference to FIG. 8, the coin-holding ends (410) of the locking arms (41) will be pushed by the coin. The locking arms (41) will be pushed to rotate, and the key-clamping ends (411) will disengage from the cavities (311) in the key (31) and the locking effect applied to the key (31) will be released. Therefore, the key (31) can be taken out of the key hole (12). After the key (31) is taken out from the housing (1), the connecting arm (43) will be forced to move downward by the restitution force provided by the first biasing member (44). The tabs (413) on the locking arms (41) will engage with the notches (431) in the connecting arm (43), such that the locking arms (41) will not pivotally rotate relative to the housing (1) due to the blocking of the connecting arm (43). Consequently, the coin will be securely held between the concave surface (412) on the coin-holding ends (410) of the locking arms (41) and will not be taken out of the slot (11). At this time, the coin will push against the stop (42) of the second biasing member (42), and the second biasing member (42) provides a biasing force to the coin. Accordingly, a cart can be disconnected from the other, and a purchaser can use the cart to carry purchases.

When a key (31) is inserted into the key hole (12) and the key-clamping ends (411) of the locking arms (41) are pushed away by the key (31), the coin-holding ends (410) will move away from the coin and the holding effect applied to the coin is released. Accordingly, the coin will be pushed to move out of the slot (11) by the force provided by the second biasing member (42). With the biasing force provided by the second biasing member (42), the coin will be actually pushed out of and discharged from the slot (11), and the use of the slot lock is convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A slot lock for a cart comprising:
a housing having:
an upper shell with two ends and having a slot defined in one end and a key hole defined in the other end and corresponding to the slot; and
a lower shell combined to the upper shell;
a key connected to the housing; and
a locking device mounted in the housing and having
two locking arms pivotally mounted in the upper shell and each having
a key-clamping end extending toward the key hole;
a tab extending from the locking arm near the key-clamping end; and
a coin-holding end opposite to the key-clamping end and having a concave surface;
a connecting arm mounted between the locking arms and having two ends engaging respectively with the tabs on the locking arms;
a first biasing member mounted between the upper shell and the connecting arm and having two ends connected respectively to the locking arms to provide a restitution force to the connecting arm and the locking arms; and
a second biasing member mounted in the upper shell near the slot and having two ends connected to the upper shell and a middle provided with a stop corresponding to the slot.

2. The slot lock as claimed in claim 1, wherein the upper shell further has a partition wall and having an elongated through hole defined through the partition wall and aligning with the slot and the key hole; and
the second biasing member is mounted in the upper shell between the slot and the partition wall.
